(19) United States
(12) Patent Application Publication
(10) Pub. No.: US 2026/0362454 A1
(43) Pub. Date: Nov. 12, 2026

(54) INTER-USER EQUIPMENT COORDINATION FOR MULTI-CONSECUTIVE-SLOT TRANSMISSIONS

(71) Applicant: QUALCOMM Incorporated, San Diego, CA (US)

(72) Inventors: Shaozhen GUO, Beijing (CN); Chih-Hao LIU, San Diego, CA (US); Changlong XU, Beijing (CN); Jing SUN, San Diego, CA (US); Luanxia YANG, Beijing (CN); Siyi CHEN, Beijing (CN); Xiaoxia ZHANG, San Diego, CA (US); Hao XU, Beijing (CN)

(21) Appl. No.: 19/131,838

(22) PCT Filed: Jan. 11, 2023
(86) PCT No.: PCT/CN2023/071769

§ 371 Date: May 21, 2025

(51) Int. Cl. H04W 72/25; H04B 17/318; H04W 28/26; H04W 72/0446; H04W 72/0453; H04W 72/563

(52) U.S. Cl. CPC H04W 72/25; H04B 17/318; H04W 28/26; H04W 72/0446; H04W 72/0453; H04W 72/563

(57) ABSTRACT

Various aspects of the present disclosure generally relate to wireless communication. In some aspects, a first user equipment (UE) may receive, from a second UE, first sidelink control information that indicates a first reserved resource for a first physical sidelink shared channel (PSSCH) transmission. The UE may receive, from a third UE, second SCI that indicates a second reserved resource for a second PSSCH transmission, at least one of the first reserved resource or the second reserved resource comprising a multi-consecutive slot transmission resource. The UE may transmit, based on the first reserved resource and the second reserved resource being partially overlapping with each other within a set of frequency resources and satisfying an inter-UE blocking condition, inter-UE coordination information comprising an inter-UE blocking indication associated with the first reserved resource and the second reserved resource. Numerous other aspects are described.

### FIELD OF THE DISCLOSURE

Aspects of the present disclosure generally relate to wireless communication and to techniques and apparatuses for inter-user equipment (UE) coordination for performing inter-UE blocking mitigation in multi-consecutive-slot transmissions.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

The technology described provides for improved resource utilization, data transmission integrity, and user experience. For example, a coordinating sidelink user equipment (UE) may detect a potential for inter-UE blocking, in which a transmission, by one UE on a reserved resource, may cause another UE to fail a listen-before-talk (LBT) procedure on a resource that at least partially overlaps with the reserved resource. The coordinating UE may provide inter-UE coordination information to at least one of the UEs that may be used to perform an inter-UE blocking mitigation operation. For example, the inter-UE blocking mitigation operation may include maintaining one or more gap symbols in a slot in which the potential inter-UE blocking is detected and/or reselecting resources that are not overlapping in time with the other UE's reserved resources. In this way, the LBT procedure may be successful since it may be free from inter-UE blocking. As a result, some aspects may facilitate more efficient resource utilization, more reliable sidelink communications, and more reliable use of multi-consecutive slot transmission (MCSt) resources, thereby improving network performance.

One aspect provides a method for wireless communication by a first UE. The method includes receiving, from a second UE, first sidelink control information (SCI) that indicates a first reserved resource for a first physical sidelink shared channel (PSSCH) transmission; receiving, from a third UE, second SCI that indicates a second reserved resource for a second PSSCH transmission, at least one of the first reserved resource or the second reserved resource comprising an MCSt resource; and transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource.

Another aspect provides a method for wireless communication by a second UE. The method includes transmitting first SCI that indicates a first reserved resource for a first PSSCH transmission; and receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising an MCSt resource.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture.

FIGS. 4A, 4B, 4C, and 4D depict aspects of data structures for a wireless communications network, such as wireless communications network of FIG. 1, in accordance with the present disclosure.

FIG. 5 is a diagram illustrating an example of sidelink communications, in accordance with the present disclosure.

FIG. 6 is a diagram illustrating an example associated with inter-UE coordination for multi-consecutive-slot transmissions (MCSts), in accordance with the present disclosure.

FIG. 7A is a diagram illustrating an example associated with inter-UE coordination for MCSts, in accordance with the present disclosure.

FIG. 7B is a diagram illustrating an example associated with inter-UE coordination for MCSts, in accordance with the present disclosure.

FIG. 8A is a diagram illustrating an example associated with inter-UE coordination for MCSts, in accordance with the present disclosure.

FIG. 8B is a diagram illustrating an example associated with inter-UE coordination for MCSts, in accordance with the present disclosure.

FIG. 9 shows a method for wireless communications by a first UE, in accordance with the present disclosure.

FIG. 10 shows a method for wireless communications by a second UE, in accordance with the present disclosure.

FIG. 11 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for inter-user equipment (UE) coordination for performing inter-UE blocking mitigation in multi-consecutive-slot transmissions (MCSts).

In some cases, MCSt can be supported for UE-based resource allocation in sidelink communications. To support continuous transmission for a UE, gap symbols within MCSt resources may be used for data transmission as they may not be needed to be used as gaps. However, using a gap symbol for data transmission of one UE may block the transmission of another UE in the same set of frequency resources. This scenario may be referred to as “inter-UE blocking.” In some cases, inter-UE blocking can arise in scenarios in which frequency division multiplexed transmissions associated with different UEs have different starting times. In some cases, a UE can determine whether a resource pool includes multiple frequency division multiplexed transmissions by detecting sidelink control information (SCI) from one or more other UEs. However, due to half-duplex constraints of UEs, a UE may fail to detect some SCI (e.g., when the SCI is transmitted at a time in which the UE is also transmitting). Failure to detect SCI can result in failure to mitigate inter-UE blocking, which may negatively impact sidelink network performance.

Some aspects of the techniques and apparatuses described herein may provide for using inter-UE coordination to detect and mitigate potential inter-UE blocking among frequency division multiplexed transmissions associated with MCSt resources. In some aspects, for example, a first UE may be implemented as a coordinating UE (e.g., a UE that performs a coordinating function in which the UE refrains from transmitting while attempting to detect SCI). The first UE may detect first SCI that indicates a first reserved resource for data transmission from a second UE and may detect second SCI that indicates a second reserved resource for data transmission from a third UE. If at least one of the first reserved resource or the second reserved resource is an MCSt resource, and if the first reserved resource and the second reserved resource are in the same set of frequency resources and are at least partially overlapping in a time domain, the first UE may transmit inter-UE coordination information to at least one of the second or third UEs. The first UE may transmit the inter-UE coordination information based on the first reserved resource and the second reserved resource satisfying an inter-UE blocking condition, thereby indicating a potential for inter-UE blocking. The inter-UE coordination information may include an inter-UE blocking indication that indicates a potential for inter-UE blocking, in which a transmission, by one UE on a reserved resource, may cause another UE to fail a listen-before-talk (LBT) procedure on a resource that at least partially overlaps with the reserved resource. In some aspects, based on the inter-UE blocking information, the UE that receives the inter-UE coordination information may perform an inter-UE blocking mitigation operation. For example, the inter-UE blocking mitigation operation may include maintaining one or more gap symbols in a slot in which the potential inter-UE blocking is detected and/or reselecting resources that are not overlapping in time with the other UE's reserved resources.

In this way, the LBT procedure may be successful since it may be free from inter-UE blocking. As a result, some aspects may facilitate more efficient resource utilization, more reliable sidelink communications, and more reliable use of MCSt resources, thereby improving network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

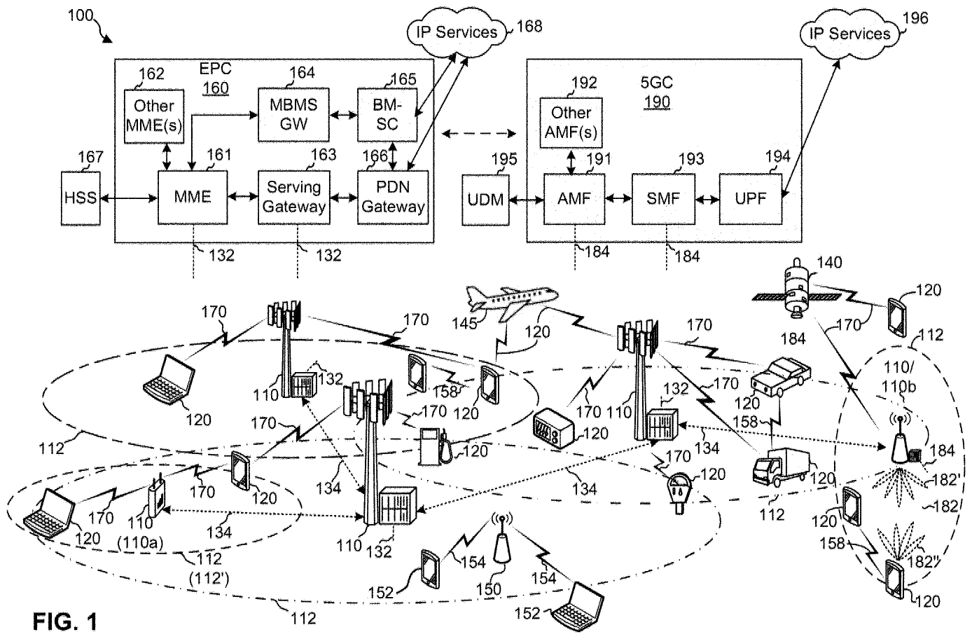

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

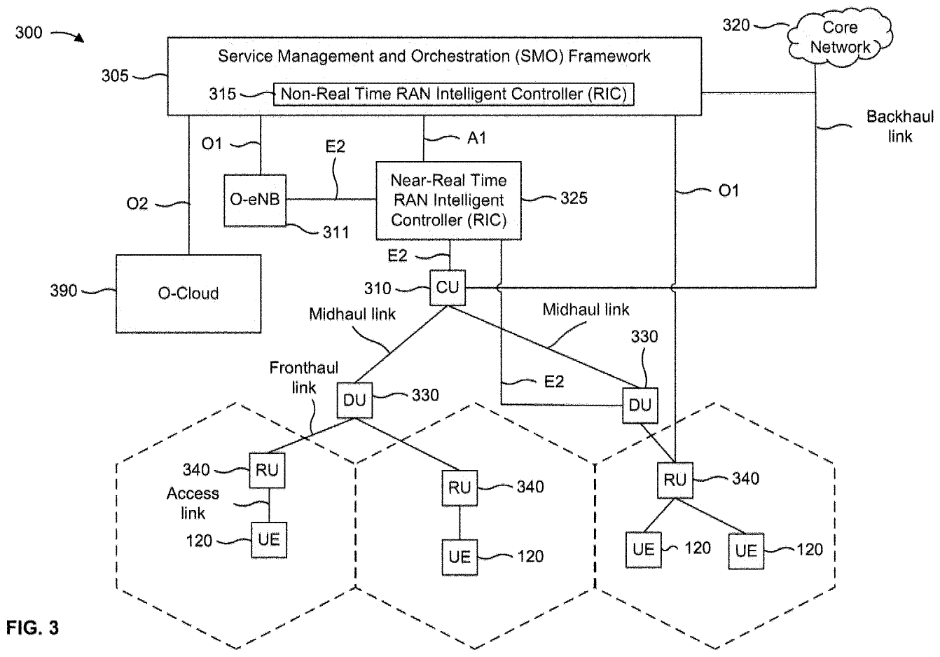

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz 7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mm Wave radio frequency bands (e.g., a mm Wave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

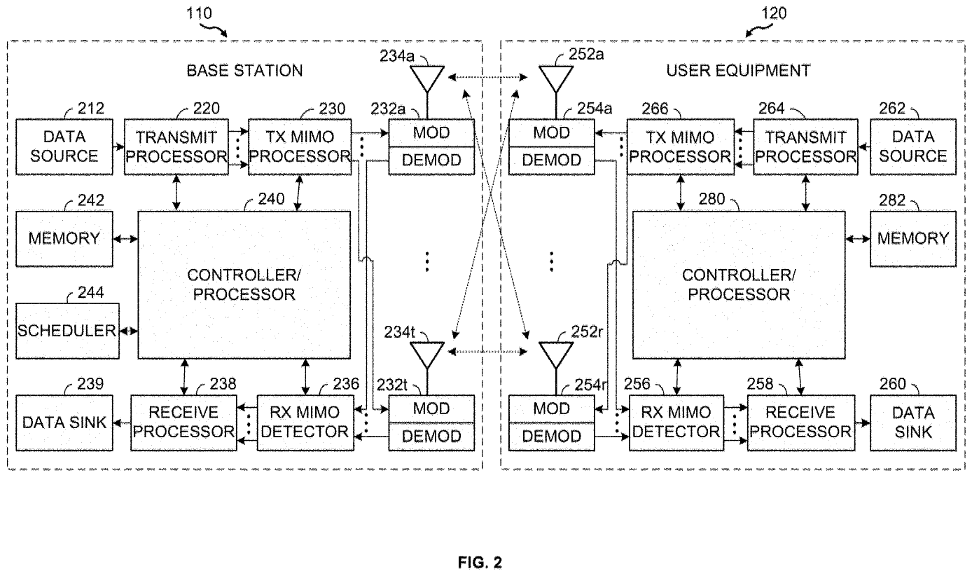

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

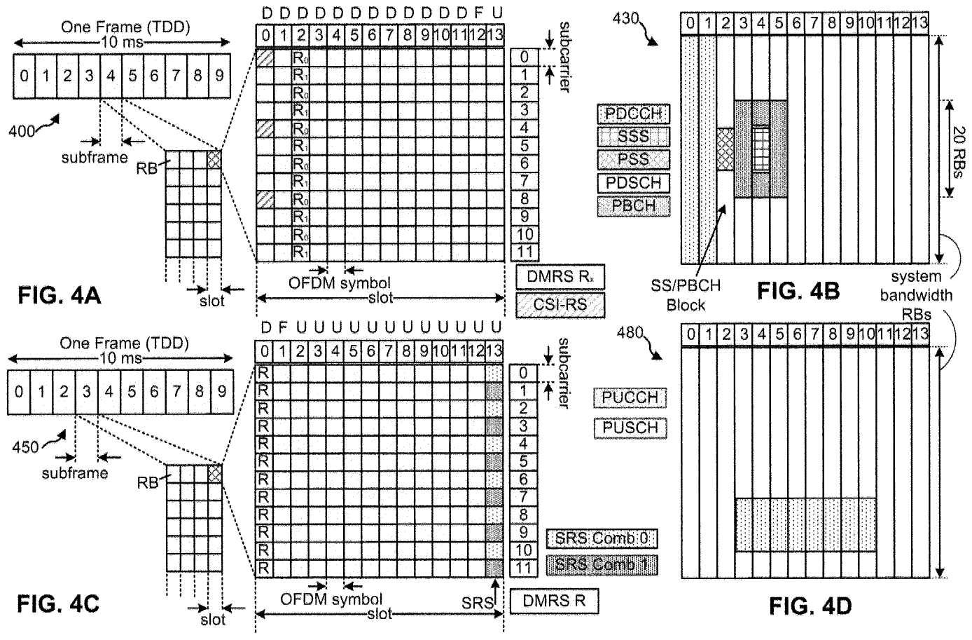

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

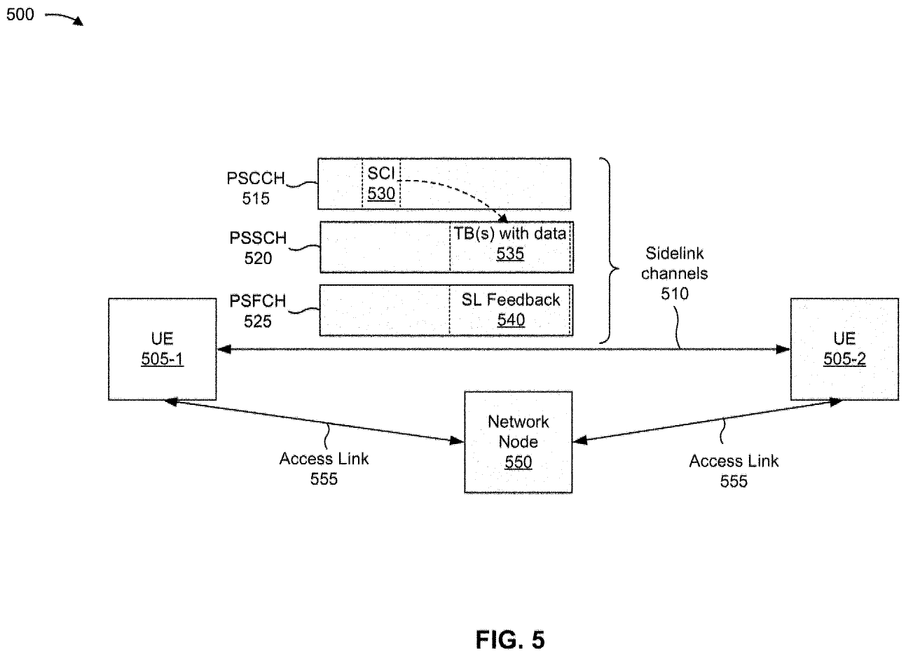

FIG. 5 is a diagram illustrating an example 500 of sidelink communications, in accordance with the present disclosure.

As shown in FIG. 5, a first UE 505-1 may communicate with a second UE 505-2 (and one or more other UEs 505) via one or more sidelink channels 510. The UEs 505-1 and 505-2 may communicate using the one or more sidelink channels 510 for P2P communications, D2D communications, V2X communications (e.g., which may include V2V communications, V2I communications, and/or V2P communications) and/or mesh networking. In some aspects, the UEs 505 (e.g., UE 505-1 and/or UE 505-2) may correspond to one or more other UEs described elsewhere herein, such as UE 120. In some aspects, the one or more sidelink channels 510 may use a PC5 interface and/or may operate in a high frequency band (e.g., the 5.9 GHz band). Additionally, or alternatively, the UEs 505 may synchronize timing of transmission time intervals (TTIs) (e.g., frames, subframes, slots, or symbols) using global navigation satellite system (GNSS) timing.

As further shown in FIG. 5, the one or more sidelink channels 510 may include a physical sidelink control channel (PSCCH) 515, a PSSCH 520, and/or a PSFCH 525. The PSCCH 515 may be used to communicate control information, similar to a physical downlink control channel (PDCCH) and/or a PUCCH used for cellular communications with a BS 110 via an access link or an access channel. The PSSCH 520 may be used to communicate data, similar to a physical downlink shared channel (PDSCH) and/or a physical uplink shared channel (PUSCH) used for cellular communications with a BS 110 via an access link or an access channel. For example, the PSCCH 515 may carry SCI 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as HARQ feedback (e.g., acknowledgement or negative acknowledgement (ACK/NACK) information), transmit power control (TPC), and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an acknowledgment (ACK) in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. The HARQ process refers to the determination of whether to report an ACK or NACK associated with a transmission, a time resource associated with the transmission (e.g., a symbol or a slot), and/or a frequency resource associated with the transmission (e.g., a resource block (RB), a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 520, such as a HARQ process ID, a new data indicator (NDI), a source identifier, a destination identifier, and/or a channel state information (CSI) report trigger.

In some aspects, the one or more sidelink channels 510 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 530) may be transmitted in sub-channels using specific resource blocks (RBs) across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505-1 may operate using a sidelink transmission mode (e.g., Mode 1) where resource selection and/or scheduling is performed by a BS 110 (e.g., a base station, a CU, or a DU). For example, the UE 505-1 may receive a grant (e.g., in DCI or in a radio resource control (RRC) message, such as for configured grants) from the BS 110 (e.g., directly or via one or more network nodes) for sidelink channel access and/or scheduling. In some aspects, a UE 505-1 may operate using a transmission mode (e.g., Mode 2) where resource selection and/or scheduling is performed by the UE 505-1 (e.g., rather than a BS 110). In some aspects, the UE 505-1 may perform resource selection and/or scheduling by sensing channel availability for transmissions. For example, the UE 505-1 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 505-1 may perform resource selection and/or scheduling using SCI 530 received in the PSCCH 515, which may indicate occupied resources and/or channel parameters. Additionally, or alternatively, the UE 505-1 may perform resource selection and/or scheduling by determining a channel busy ratio (CBR) associated with various sidelink channels, which may be used for rate control (e.g., by indicating a maximum number of resource blocks that the UE 505-1 can use for a particular set of subframes).

In the transmission mode where resource selection and/or scheduling is performed by a UE 505-1, the UE 505-1 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505-1 may generate a sidelink grant that indicates one or more parameters for semi-persistent scheduling (SPS), such as a periodicity of a sidelink transmission. Additionally, or alternatively, the UE 505-1 may generate a sidelink grant for event-driven scheduling, such as for an on-demand sidelink message.

As shown, a network node 550 may communicate with the UE 505-1 and/or the UE 505-2 (e.g., directly or via one or more network nodes), such as via an access link 555. A direct link between the UEs 505-1 and 505-2 (e.g., via a PC5 interface) may be referred to as a sidelink, and a direct link between a network node 550 and a UE 505-1 or 505-2 (e.g., via a Uu interface) may be referred to as an access link. Sidelink communications may be transmitted via the sidelink, and access link communications may be transmitted via the access link. An access link communication may be either a downlink communication (from the network node 550 to the UE 505-1 or 505-2) or an uplink communication (from a UE 505-1 or 505-2 to the network node 550).

Additionally, or alternatively, the UE 505-1 and/or 505-2 can perform resource selection and/or scheduling using SCI 530 received in the PSCCH 515, which can indicate occupied resources and/or channel parameters. Additionally, or alternatively, the UE 505-1 and/or 505-2 can perform resource selection and/or scheduling by determining a channel busy ratio (CBR) associated with various sidelink channels, which can be used for rate control (e.g., by indicating a maximum number of resource blocks that the UE 505-1 and/or 505-2 can use for a particular set of subframes).

In the second transmission mode, the UE 505-1 and/or 505-2 can generate sidelink grants, and can transmit the grants in SCI 530. A sidelink grant can indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), and/or one or more subframes to be used for the upcoming sidelink transmission. In some aspects, a UE 505-1 and/or 505-2 can generate a sidelink grant that indicates one or more parameters for semi-persistent scheduling (SPS), such as a periodicity of a sidelink transmission. Additionally, or alternatively, the UE 505-1 and/or 505-2 can generate a sidelink grant for event-driven scheduling, such as for an on-demand sidelink message.

Some aspects described herein relate to an unlicensed radio frequency spectrum band, which may be used for communications in a wireless network, such as wireless network 100. In some aspects, the unlicensed radio frequency spectrum band can be used by BSs 110 and UEs 120 of a cellular network for cellular communications (e.g., NR communications), and/or by Wi-Fi access points and Wi-Fi stations of a Wi-Fi network for Wi-Fi communications, among other examples. The unlicensed radio frequency spectrum band can be used in the cellular network in combination with, or independent from, a licensed radio frequency spectrum band. In some examples, the unlicensed radio frequency spectrum band can be a radio frequency spectrum band for which a device may need to contend for access because the radio frequency spectrum band is available, at least in part, for unlicensed use, such as Wi-Fi use.

Prior to gaining access to, and communicating over, an unlicensed sidelink radio frequency spectrum band, a UE can perform a LBT procedure to contend for access to the unlicensed radio frequency spectrum band. An LBT procedure, sometimes referred to as a clear channel assessment (CCA) procedure, can include performing a CCA to determine whether a channel of the unlicensed sidelink radio frequency spectrum band is available. When it is determined that the channel of the unlicensed sidelink radio frequency spectrum band is not available (e.g., because another apparatus is already using the channel of the unlicensed sidelink radio frequency spectrum band), a CCA procedure can be performed for the channel again at a later time. In environments in which a UE can be starved of access to a channel of an unlicensed sidelink radio frequency spectrum band due to Wi-Fi activity, an extended CCA procedure can be employed to increase the likelihood that the UE will successfully contend for access to the channel of the unlicensed sidelink radio frequency spectrum band. An extended CCA procedure involves the performance of a random number of CCA procedures (from 1 to q), in accordance with an extended CCA counter.

Regardless of whether a single CCA procedure is performed or multiple CCA procedures are performed, each CCA procedure may include detecting or sensing an energy level on the channel of the unlicensed sidelink radio frequency spectrum band and determining whether the energy level is below a threshold. When the energy level satisfies (e.g., does not equal or exceed) the threshold, the CCA procedure is deemed to be successful and the transmitting device may gain access to the unlicensed channel for a duration that may be referred to as a channel occupancy time (COT) during which the transmitting device can perform transmissions without performing additional LBT operations. When the energy level does not satisfy the threshold, the CCA procedure is unsuccessful and contention to access the unlicensed channel may be deemed unsuccessful.

When a CCA procedure or extended CCA procedure is successful, a transmission may be made over the channel of the unlicensed sidelink radio frequency spectrum band. When a packet error is encountered (e.g., due to a collision of transmissions made by two or more transmitting apparatuses or due to poor channel conditions), a HARQ-based retransmission can be performed. In some examples, the retransmission can be modified from the original transmission using rate adaptation (e.g., based at least in part on a CQI reported by a UE).

An LBT category can define a channel sensing duration during which a UE contending for access to a channel performs a CCA procedure. The channel sensing duration can indicate a length of time during which the UE detects or senses an energy level on the channel to determine whether the energy level is less than (or equal to) a threshold. If the energy level is less than (or equal to) the threshold, then the LBT/CCA procedure is successful, and the UE transmits a communication. If the energy level is greater than (or equal to) the threshold, then the CCA procedure is unsuccessful and the UE can wait for a period of time (e.g., a backoff duration) before performing the CCA procedure again.

Example LBT categories include category one (Cat 1) LBT, category two (Cat 2) LBT, category three (Cat 3) LBT, and category four (Cat 4) LBT. In Cat 1 LBT, also referred to as no LBT, an LBT procedure is not performed prior to transmission of a communication on the channel. In Cat 2 LBT, the channel sensing duration is fixed (e.g., without random back-off). For example, a 16 microsecond channel sensing duration is used for 16 microsecond Cat 2 LBT, and a 25 microsecond channel sensing duration is used for 25 microsecond Cat 2 LBT. In Cat 3 LBT, the channel sensing duration is fixed (e.g., a contention window has a fixed size), and random back-off is used. In Cat 4 LBT, the channel sensing duration is variable (e.g., a contention window has a variable size), and random back-off is used.

In Cat 4 LBT, the channel sensing duration may be variable depending on whether the device contending for access to the channel senses interference (e.g., an energy level greater than or equal to a threshold). Using a Cat 4 LBT procedure, the device may select a minimum channel sensing duration, which may be defined by a channel access priority class (CAPC) associated with the Cat 4 LBT procedure being used by the device. For example, four different CAPCs may be associated with Cat 4 LBT, with the lowest CAPC value (e.g., CAPC 0) being associated with the highest priority for Cat 4 LBT (e.g., the shortest contention window size and shortest back-off duration), and the highest CAPC value (e.g., CAPC 3) being associated with the lowest priority for Cat 4 LBT (e.g., the longest contention window size and longest back-off duration). Generally, a higher CAPC value (e.g., a higher CAPC index) is associated with a lower priority. In Cat 4 LBT, if the device detects interference in the minimum channel sensing duration for a CCA procedure as defined by a CAPC for the Cat 4 LBT procedure, then the device may increase the channel sensing duration for the next CCA procedure.

In some cases, inter-UE coordination may be implemented to improve reliability and efficiency. In the case of the second transmission mode operations, each transmitting UE can perform a sensing operation to find occupied and/or available resources to utilize for an upcoming transmission. For example, UEs participating in sidelink communications can share resource information (e.g., a reservation received from other UEs in the system) indicating time and frequency resources reserved for one or more future transmissions. In some cases, for example, inter-UE coordination in the second transmission mode of sidelink communications can be specified according to an inter-UE coordination scheme in which a first UE transmits inter-UE coordination information to a second UE. The inter-UE coordination can include a set of preferred resources and/or a set of non-preferred resources. In some cases, the inter-UE coordination can include additional coordination information. The UE can use the coordination information for resource selection and/or re-selection.

In some cases, multi-consecutive slots transmission can be supported for mode 2 resource allocation in sidelink communications. In this case, a single SCI may reserve a multi-slot resource for transmission. To support continuous transmission for a UE, the gap symbols within consecutive multi-slot resources may be used for PSSCH transmission as they may not be needed to be used as gaps. However, using a gap symbol for PSSCH transmission of one UE may block the transmission of another UE in the same resource block (RB) set if the UEs use different subchannels or interlaces (e.g., in cases in which the transmission resources are frequency division multiplexed). This scenario may be referred to as “inter-UE blocking.” Whether gap symbols can be used for PSSCH transmission may depends on whether there are other transmissions from other UEs frequency division multiplexed in the same set of frequency resources. A set of frequency resources may refer to an RB set and/or an LBT bandwidth.

In some cases, inter-UE blocking can arise in scenarios in which frequency division multiplexed transmissions associated with different UEs have different starting times. In some cases, a UE can determine whether there are multiple frequency division multiplexed transmissions by detecting SCI from one or more other UEs. In this case, inter-UE blocking due to different starting times can be avoided such as, for example, by selecting MCSt resources with a same starting time or by selecting time division multiplexed resources. However, due to half-duplex constraints of UEs, a UE may fail to detect some SCI (e.g., when the SCI is transmitted at a time in which the UE is also transmitting). Failure to detect SCI can result in failure to mitigate inter-UE blocking, which may negatively impact sidelink network performance.

Some aspects of the techniques and apparatuses described herein may provide for using inter-UE coordination to detect and mitigate potential inter-UE blocking among frequency division multiplexed transmissions associated with MCSt resources. In some aspects, for example, a first UE (e.g., a UE-A) may detect (e.g., receive) first SCI that indicates a first reserved resource for PSSCH transmission from a second UE (e.g., a UE-B) and may detect second SCI that indicates a second reserved resource for PSSCH transmission from a third UE (e.g., a UE-C). If at least one of the first reserved resource or the second reserved resource is an MCSt resource, and if the first reserved resource and the second reserved resource are in the same set of frequency resources (e.g., an RB set or an LBT bandwidth) and are at least partially overlapping in a time domain, the first UE may transmit inter-UE coordination information to at least one of the second or third UEs. The first UE may transmit the inter-UE coordination information based on the first reserved resource and the second reserved resource satisfying an inter-UE blocking condition. The inter-UE coordination information may include an inter-UE blocking indication associated with the first reserved resource and the second reserved resource. In some aspects, based on the inter-UE blocking information, the UE that receives the inter-UE coordination information may perform an inter-UE blocking mitigation operation. Performing the inter-UE blocking mitigation operation may include maintaining one or more gap symbols in a slot that starts prior to a first slot of the second reserved resource. In some aspects, performing the inter-UE blocking mitigation operation may include performing a resource reselection procedure. In this way, some aspects may facilitate mitigation of inter-UE blocking based on inter-UE coordination information, thereby positively impacting sidelink network performance.

As indicated above, FIG. 5 is provided as an example. Other examples may differ from what is described with respect to FIG. 5.

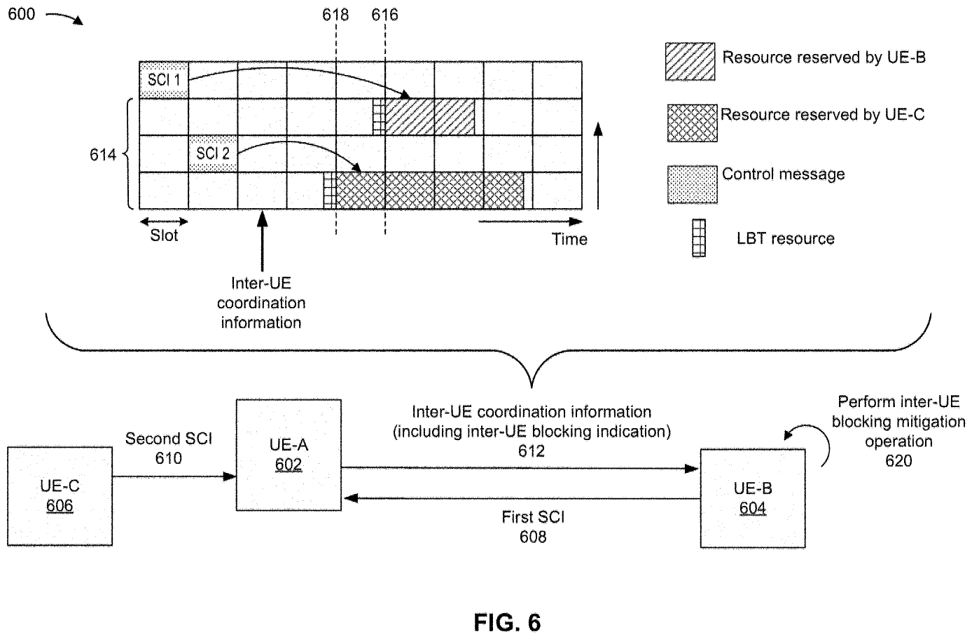

FIG. 6 is a diagram illustrating an example 600 associated with inter-UE coordination for MCSts, in accordance with the present disclosure. As shown, a UE-A 602, a UE-B 604, and a UE-C 606 may communicate with one another. In some aspects, the UE-A 602, UE-B 604, and/or the UE-C 606 may be, be similar to, include, or be included in the UE 505-1 and/or the UE 505-2 depicted in FIG. 5, and/or the UE 120 depicted in FIGS. 1, 2, and 4.

As shown by reference number 608, the UE-B 604 may transmit, and the UE-A 602 may receive, first SCI (shown as “SCI 1”). The first SCI may indicate a first reserved resource (shown as “resource reserved by UE-B”) for a first PSSCH transmission. As shown by reference number 610, the UE-C 606 may transmit, and the UE-A 602 may receive, second SCI (shown as “SCI 2”). The second SCI may indicate a second reserved resource (shown as “resource reserved by UE-C”) for a second PSSCH transmission. In some aspects, the UE-A 602 may be a coordination UE and, as shown, may not be a destination UE of either of the first SCI or the second SCI. In some other aspects, the UE-A 602 may be the destination UE of UE-B 604 or UE-C 606 (e.g., the UE-B 604 may reserve the first reserved resource for PSSCH transmission towards UE-A 602 or the UE-C 606 may reserve the second reserved resource for PSSCH transmission towards UE-A). In some aspects, at least one of the first reserved resource or the second reserved resource may include an MCSt resource. Although both the first and second reserved resources are shown, in FIG. 6, as being MCSt resources, in some aspects, only one of the first reserved resource or the second reserved resource may be an MCSt resource. As shown, the first reserved resource may be frequency division multiplexed with the second reserved resource.

As shown by reference number 612, the UE-A 602 may transmit, and the UE-B 604 may receive, inter-UE coordination information. In some aspects, the inter-UE coordination information may include an inter-UE blocking indication associated with the first reserved resource and the second reserved resource. For example, the inter-UE blocking indication may be associated with the first reserved resource and the second reserved resource as a result of indicating a potential for inter-UE blocking between the first and second reserved resources. For example, since the second reserved resource starts before the first reserved resource, an LBT attempt associated with the LBT resource occurring just before the start of the first resource may fail due to detection of transmissions associated with the second reserved resource that overlap, in the time domain, with the LBT resource. In some aspects, the inter-UE coordination information may indicate inter-UE blocking mitigation information for use in performing an inter-UE blocking mitigation operation.

In some aspects, the UE-A 602 may transmit the inter-UE coordination information based on the first reserved resource and the second reserved resource being partially overlapping with each other within a set 614 of frequency resources and based on the first reserved resource and the second reserved resource satisfying an inter-UE blocking condition. For example, the UE-A 602 may transmit the inter-UE coordination information responsive to determining that the first reserved resource and the second reserved resource are at least partially overlapping with each other within the set 614 of frequency resources and determining that the first reserved resource and the second reserved resource satisfy an inter-UE blocking condition.

In some aspects, for example, the first reserved resource may have a first starting time resource and the second reserved resource may have a second starting time resource. For example, as shown in FIG. 6, the first starting time resource may be the reserved slot of the first reserved resource adjacent to (immediately to the right of) a first starting time 616 of the first reserved resource. Similarly, the second starting time resource may be the reserved slot of the second reserved resource adjacent to (immediately to the right of) a second starting time 618 of the second reserved resource. The first reserved resource and the second reserved resource may satisfy the inter-UE blocking condition (e.g., a first inter-UE blocking condition, which may be referred to herein as “inter-UE blocking condition 1”) based on the first starting time resource being different from the second starting time resource. For example, the inter-UE blocking condition may be satisfied as a result of the first starting time resource being different from the second starting time resource.

Resource selection in sidelink communications may be influenced by transmission priorities that may be configured by a network (e.g., by a BS), by a wireless communication standard, and/or by the UEs themselves. In some aspects, the inter-UE blocking condition may be related to transmission priorities. For example, in some aspects, the first reserved resource may be associated with a first transmission priority value that indicates a first transmission priority and the second reserved resource may be associated with a second transmission priority value that indicates a second transmission priority. In some aspects, the first reserved resource and the second reserved resource may satisfy the inter-UE blocking condition (e.g., a second inter-UE blocking condition, which may be referred to herein as “inter-UE blocking condition 2”) when the second starting time resource occurs after the first starting time resource and based on the second transmission priority value being smaller than the first transmission priority value. Transmission priority values may be inversely related to a level of priority with respect to another priority. For example, if the second transmission priority value is smaller than the first transmission priority value, the second reserved resource may have a higher priority than the first reserved resource. Accordingly, in some aspects, the first reserved resource and the second reserved resource may satisfy the inter-UE blocking condition as a result of the second priority being higher than the first priority.

In some aspects the first reserved resource may be associated with a first CAPC value that indicates a first CAPC and the second reserved resource may be associated with a second CAPC value that indicates a second CAPC. In some aspects, the first reserved resource and the second reserved resource may satisfy the inter-UE blocking condition (e.g., a third inter-UE blocking condition, which may be referred to herein as “inter-UE blocking condition 3”) when the second starting time resource occurs after the first starting time resource and based on the second CAPC value being smaller than the first CAPC value. CAPC values may be inversely related to CAPCs with respect to other CAPCs. For example, if the second CAPC value is smaller than the first CAPC value, the second reserved resource may belong to a higher CAPC than the first reserved resource. Accordingly, in some aspects, the first reserved resource and the second reserved resource may satisfy the inter-UE blocking condition as a result of the second CAPC being higher than the first CAPC. In some aspects, the first SCI may indicate the first CAPC value and the second SCI may indicate the second CAPC value.

In some aspects, the first reserved resource and the second reserved resource may satisfy the inter-UE blocking condition (e.g., a fourth inter-UE blocking condition, which may be referred to herein as “inter-UE blocking condition 4”) based on a distance between the UE-B 604 and the UE-C 606 satisfying an inter-UE distance threshold. For example, the UE-A 602 may be configured with an inter-UE distance threshold and may determine a first geographic location (or a first relative location with respect to the UE-A 602) of the UE-B 604 based on the first SCI and a second geographic location (or a second relative location with respect to the UE-A 602) of the UE-B 604 based on the second SCI. The UE-A 602 may determine that the first reserved resource and the second reserved resource satisfy the inter-UE blocking condition as a result of a distance between the UE-B 604 and the UE-C 606 satisfying an inter-UE distance threshold. For example, the first reserved resource and the second reserved resource may satisfy the inter-UE blocking condition as a result of the distance between the UE-B 604 and the UE-C 606 being less than an inter-UE distance threshold.

In some aspects, the first reserved resource and the second reserved resource may satisfy the inter-UE blocking condition (e.g., a fifth inter-UE blocking condition, which may be referred to herein as “inter-UE blocking condition 5”) based on the UE-B 604 belonging to a second UE list associated with the UE-C 606 and the UE-C 606 belonging to a first UE list associated with the UE-B 604. For example, in some aspects, the UE-B 604 may maintain, in a memory of the UE-B 604, a first UE list that indicates one or more UEs with which the UE-B 604 can communicate via a sidelink. Similarly, the UE-C 606 may maintain, in a memory of the UE-C 606, a second UE list that indicates one or more UEs with which the UE-C 606 can communicate via a sidelink. In some other aspects, the first UE list may indicate a first set of UEs from which a respective received signal strength indicator (RSSI) at the UE-B 604 satisfies a first RSSI threshold, and the second UE list may indicate a second set of UEs from which a respective RSSI at the UE-C 606 satisfies a second RSSI threshold. The first RSSI threshold may be the same as, or different from, the second RSSI threshold. In some aspects, the first reserved resource and the second reserved resource may satisfy the inter-UE blocking condition as a result of the first list indicating the UE-C 606 and the second list indicating the UE-B 604.

In some aspects, any number of the inter-UE blocking conditions (and/or any number of additional conditions) discussed above may be used for determining an inter-UE blocking scenario and triggering transmission of inter-UE coordination information. For example, in some aspects, the first reserved resource and the second reserved resource may satisfy the inter-UE blocking condition as a result of satisfaction of inter-UE blocking conditions 1 and 2; inter-UE blocking conditions 1 and 3; inter-UE blocking conditions 1, 2, and 3; inter-UE blocking conditions 1 and 4; inter-UE blocking conditions 1, 2, and 4; inter-UE blocking conditions 1, 3, and 4; inter-UE blocking conditions 1, 2, 3, and 4; inter-UE blocking conditions 1 and 5, inter-UE blocking conditions 1, 2, and 5; inter-UE blocking conditions 1, 3, and 5; inter-UE blocking conditions 1, 2, 3, and 5; and/or inter-UE blocking conditions 1, 2, 3, 4, and 5; among other examples.

In some aspects, responsive to the first reserved resource and the second reserved resource satisfying the inter-UE blocking condition, may transmit the inter-UE coordination information to the UE-B 604, the UE-C 606, or both UEs 604 and 606. In some aspects, the UE-A 602 may determine the UE to which the inter-UE coordination information is to be transmitted based on a destination condition being satisfied. For example, the UE-A 602 may transmit the inter-UE coordination to the UE-B 604 as a result of the destination condition being satisfied.

In some aspects, the destination condition may be related transmission priorities. For example, in some aspects, the UE-B 604 may be associated with a first transmission priority value and the UE-C 606 may be associated with a second transmission priority value. The destination condition (e.g., a first destination condition, which may be referred to herein as “destination condition 1”) may be satisfied based on the first transmission priority value being larger than the second transmission priority value. For example, in some aspects, the destination condition may be satisfied as a result of the first transmission priority being lower than the second transmission priority.

In some aspects, the UE-B 604 may be associated with a first CAPC value and the UE-C 606 may be associated with a second CAPC value. The destination condition (e.g., a second destination condition, which may be referred to herein as “destination condition 2”) may be satisfied based on the UE-B 604 belonging to a lower CAPC (corresponding to a larger CAPC value) than the UE-C 606. In some aspects, the first reserved resource may have a first starting time resource and the second reserved resource may have a second starting time resource, and the destination condition (e.g., a third destination condition, which may be referred to herein as “destination condition 3”) may be satisfied based on the first starting time resource occurring before the second starting time resource.

In some aspects, any number of the destination conditions (and/or any number of additional conditions) discussed above may be used for determining the recipient UE of the inter-UE coordination information. For example, in some aspects, the destination condition may be satisfied as a result of satisfaction of destination conditions 1 and 2; destination conditions 1 and 3; destination conditions 2 and 3; and/or destination conditions 1, 2, and 3; among other examples.

As shown by reference number 620, the UE-B 604 may perform an inter-UE blocking mitigation operation. In some aspects, the UE-B 604 may perform the inter-UE blocking mitigation operation based on receiving the inter-UE coordination information. For example, the UE-B 604 may perform the inter-UE blocking mitigation operation responsive to receiving the inter-UE coordination information and/or responsive to decoding an inter-UE blocking indication contained in the inter-UE coordination information, among other examples. In some aspects, performing the inter-UE blocking mitigation operation may include maintaining one or more gap symbols in a slot that starts prior to a first slot of the second reserved resource. In some other aspects, performing the inter-UE blocking mitigation operation may include performing a resource reselection procedure.

As indicated above, FIG. 6 is provided as an example. Other examples may differ from what is described with respect to FIG. 6.

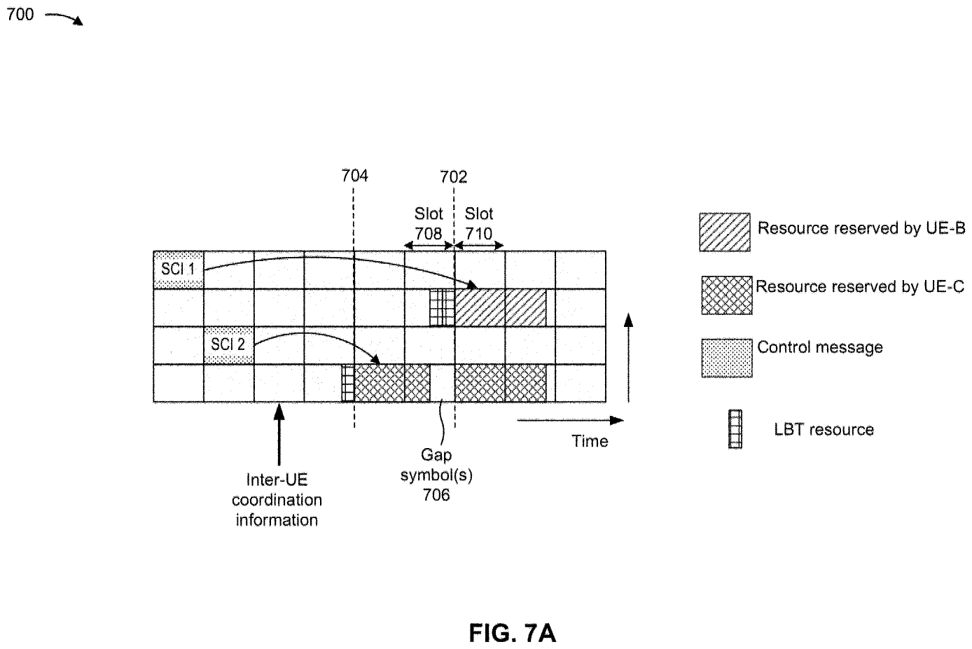

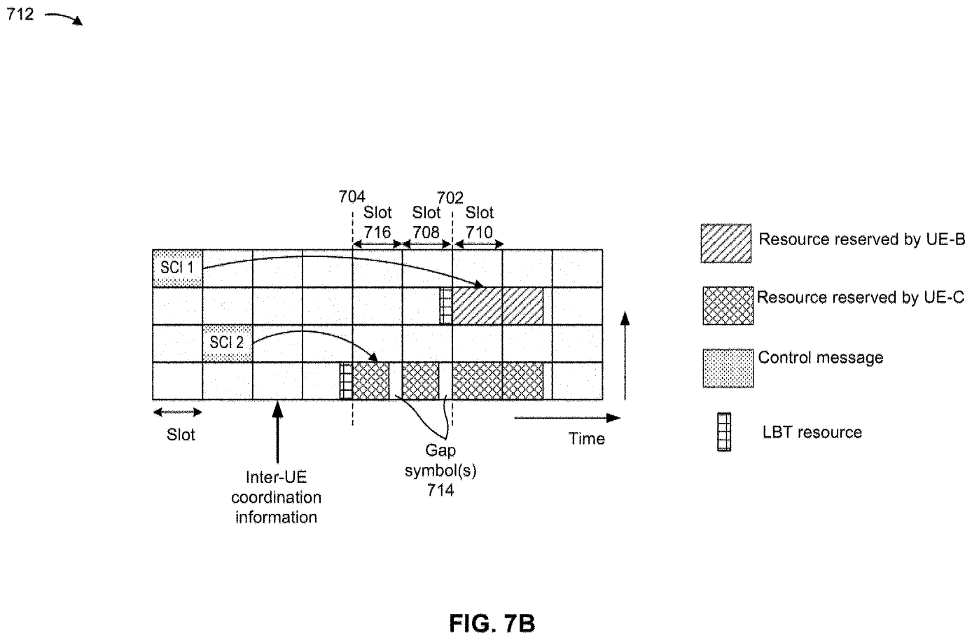

FIG. 7A is a diagram illustrating an example 700 associated with inter-UE coordination for MCSts, in accordance with the present disclosure. Example 700 depicts sidelink resource reservations associated with an inter-UE blocking mitigation operation performed by a UE such as, for example, the UE-C 606 depicted in FIG. 6. As shown, the UE-B may transmit first SCI (shown as “SCI 1”). The first SCI may indicate a first reserved resource (shown as “resource reserved by UE-B”) for a first PSSCH transmission. The UE-C may transmit second SCI (shown as “SCI 2”). The second SCI may indicate a second reserved resource (shown as “resource reserved by UE-C”) for a second PSSCH transmission. As shown, the first reserved resource and the second reserved resource are partially overlapping in the time domain and the first reserved resource has a starting time 702 that occurs after a starting time 704 of the second reserved resource.

In some aspects, as shown, the UE-C may perform a blocking mitigation operation by performing a gap maintenance operation. The UE-C may perform the gap maintenance operation by maintaining one or more gap symbols 706 in a slot 708 that starts prior to a first slot 710 of the first reserved resource. In this way, an LBT procedure performed by the UE-B in LBT resources adjacent to the starting time 702 of the first reserved resource may be free from inter-UE blocking due to the second reserved resource. In some aspects, the inter-UE coordination information may indicate a quantity of gap symbols to be maintained and a slot index associated with the slot 708. In some aspects, the quantity of gap symbols may be based on a quantity of reserved symbols indicated in at least one of the first SCI or the second SCI. For example, the quantity of gap symbols may be equal to a quantity of reserved symbols indicated in the SCI 1.

In some aspects, the quantity of reserved symbols may be associated with a type-1 LBT procedure. For example, the quantity of reserved symbols may be a quantity of symbols of a gap that is needed to perform the LBT procedure. In some aspects, the quantity of gap symbols may be based on a first quantity of reserved symbols indicated in the first SCI and a second quantity of reserved symbols indicated in the second SCI. For example, the quantity of gap symbols may be equal to a function of the sum of the first quantity of reserved symbols and the second quantity of reserved symbols. In some aspects, the quantity of reserved symbols may be equal to a maximum of the first quantity of reserved symbols and the second quantity of reserved symbols.

As indicated above, FIG. 7A is provided as an example. Other examples may differ from what is described with respect to FIG. 7A.

FIG. 7B is a diagram illustrating an example 712 associated with inter-UE coordination for MCSts, in accordance with the present disclosure. Example 712 depicts sidelink resource reservations associated with an inter-UE blocking mitigation operation performed by a UE such as, for example, the UE-C 606 depicted in FIG. 6. As shown, the UE-B may transmit first SCI (shown as “SCI 1”). The first SCI may indicate a first reserved resource (shown as “resource reserved by UE-B”) for a first PSSCH transmission. The UE-C may transmit second SCI (shown as “SCI 2”). The second SCI may indicate a second reserved resource (shown as “resource reserved by UE-C”) for a second PSSCH transmission. As shown, the first reserved resource and the second reserved resource are partially overlapping in the time domain and the first reserved resource has a starting time 702 that occurs after a starting time 704 of the second reserved resource.

In some aspects, as shown, the UE-C may perform a blocking mitigation operation by performing a gap maintenance operation. The UE-C may perform the gap maintenance operation by maintaining one gap symbol 714 in each slot 708 and 716 of one or more slots that start prior to a first slot 710 of the first reserved resource. In this way, an LBT procedure performed by the UE-B in LBT resources adjacent to the starting time 702 of the first reserved resource may be free from inter-UE blocking due to the second reserved resource. In some aspects, the inter-UE coordination information may indicate a quantity of gap symbols to be maintained and a slot index associated with the slot 708. In some aspects, the inter-UE coordination information may indicate a slot index associated with the last slot 708 of one or more slots associated with the inter-UE blocking mitigation operation.

As indicated above, FIG. 7B is provided as an example. Other examples may differ from what is described with respect to FIG. 7B.

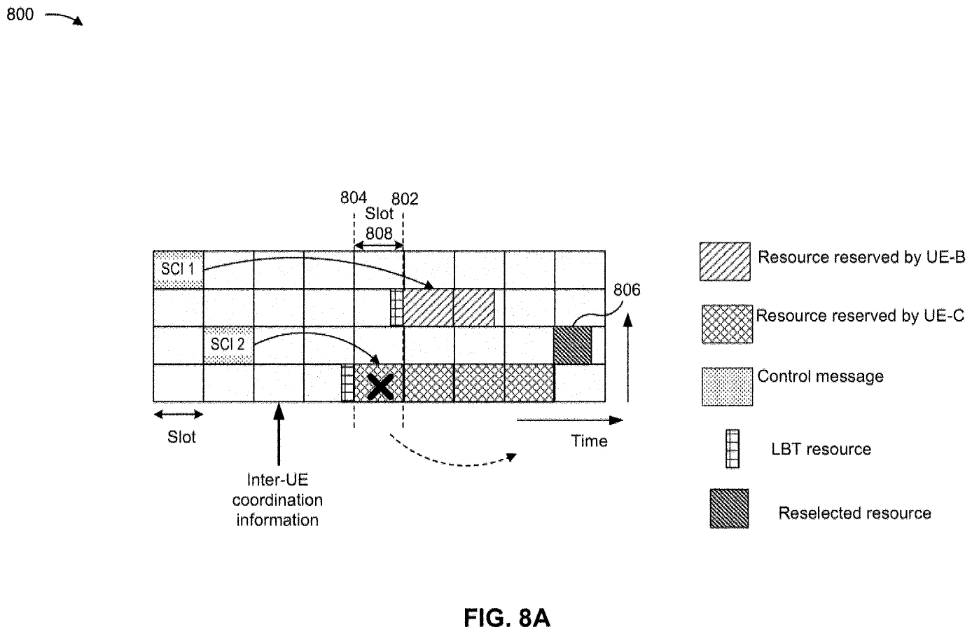

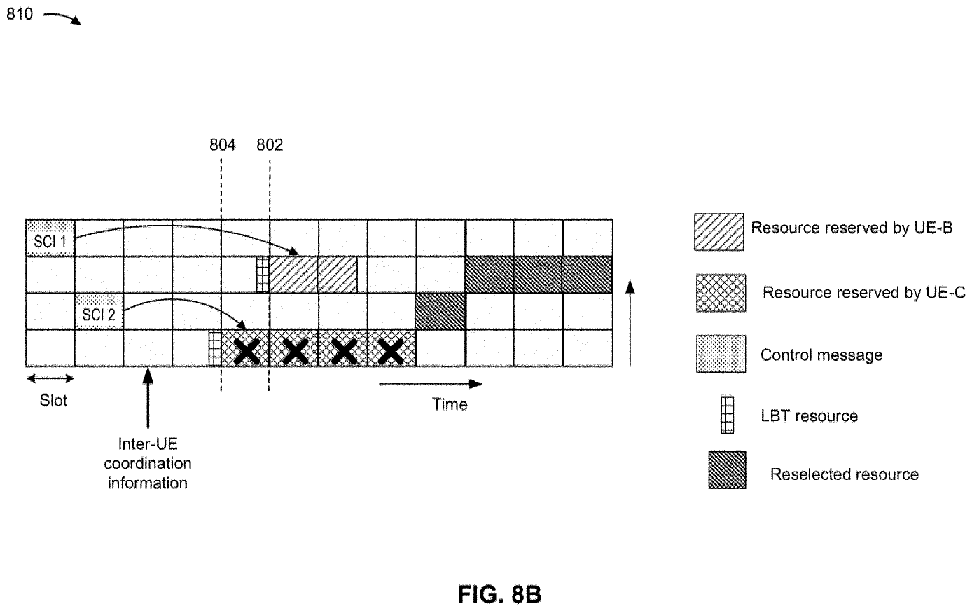

FIG. 8A is a diagram illustrating an example 800 associated with inter-UE coordination for MCSts, in accordance with the present disclosure. Example 800 depicts sidelink resource reservations associated with an inter-UE blocking mitigation operation performed by a UE such as, for example, the UE-C 606 depicted in FIG. 6. As shown, the UE-B may transmit first SCI (shown as “SCI 1”). The first SCI may indicate a first reserved resource (shown as “resource reserved by UE-B”) for a first PSSCH transmission. The UE-C may transmit second SCI (shown as “SCI 2”). The second SCI may indicate a second reserved resource (shown as “resource reserved by UE-C”) for a second PSSCH transmission. As shown, the first reserved resource and the second reserved resource are partially overlapping in the time domain and the first reserved resource has a starting time 802 that occurs after a starting time 804 of the second reserved resource.

In some aspects, as shown, the UE-C may perform a blocking mitigation operation by performing a resource reselection procedure. The UE-C may perform the resource reselection procedure by reselecting one or more single-slot resources in lieu of one or more single-slot resources of the second reserved resource. For example, as shown, the UE-C select one or more single-slot resources 806 for one or more contiguous slots 808 that occur prior to a start of the first reserved resource. In this way, an LBT procedure performed by the UE-B in LBT resources adjacent to the starting time 802 of the first reserved resource may be free from inter-UE blocking due to the second reserved resource. In some aspects, the inter-UE coordination information may indicate a slot index associated with the last slot 808 of one or more slots associated with the inter-UE blocking mitigation operation.

As indicated above, FIG. 8A is provided as an example. Other examples may differ from what is described with respect to FIG. 8A.

FIG. 8B is a diagram illustrating an example 810 associated with inter-UE coordination for MCSts, in accordance with the present disclosure. Example 810 depicts sidelink resource reservations associated with an inter-UE blocking mitigation operation performed by a UE such as, for example, the UE-C 606 depicted in FIG. 6. As shown, the UE-B may transmit first SCI (shown as “SCI 1”). The first SCI may indicate a first reserved resource (shown as “resource reserved by UE-B”) for a first PSSCH transmission. The UE-C may transmit second SCI (shown as “SCI 2”). The second SCI may indicate a second reserved resource (shown as “resource reserved by UE-C”) for a second PSSCH transmission. The second reserved resource may be an MCSt resource. As shown, the first reserved resource and the second reserved resource are partially overlapping in the time domain and the first reserved resource has a starting time 802 that occurs after a starting time 804 of the second reserved resource.

In some aspects, as shown, the UE-C may perform a blocking mitigation operation by performing a resource reselection procedure. The UE-C may perform the resource reselection procedure by selecting a new MCSt resource in lieu of the second reserved MCSt resource. In this way, an LBT procedure performed by the UE-B in LBT resources adjacent to the starting time 802 of the first reserved resource may be free from inter-UE blocking due to the second reserved resource. In some aspects, since the entire second reserved resource is being reselected, the inter-UE blocking indication may only indicate an occurrence of inter-UE blocking associated with the UE-B and the UE-C.

As indicated above, FIG. 8B is provided as an example. Other examples may differ from what is described with respect to FIG. 8B.

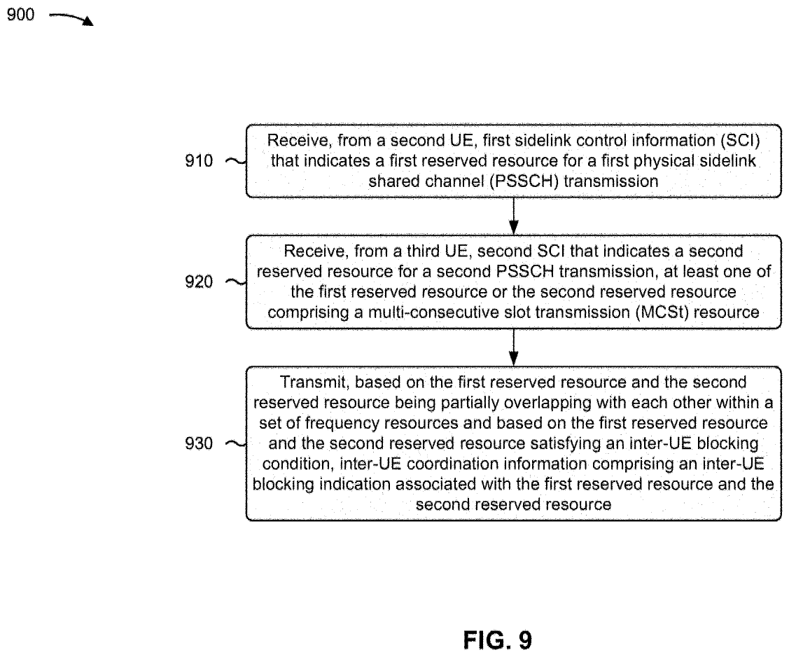

FIG. 9 shows a method 900 for wireless communications by a first UE, such as UE 120.

Method 900 begins at 910 with receiving, from a second UE, first SCI that indicates a first reserved resource for a first PSSCH transmission.

Method 900 then proceeds to step 920 with receiving, from a third UE, second SCI that indicates a second reserved resource for a second PSSCH transmission, at least one of the first reserved resource or the second reserved resource comprising an MCSt resource.

Method 900 then proceeds to step 930 with transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource.

In one aspect, the first reserved resource has a first starting time resource and the second reserved resource has a second starting time resource, wherein the first reserved resource is frequency division multiplexed with the second reserved resource, and the first reserved resource and the second reserved resource satisfy the inter-UE blocking condition based on the first starting time resource being different from the second starting time resource.

In one aspect, the first reserved resource is associated with a first transmission priority value and the second reserved resource is associated with a second transmission priority value, wherein the second starting time resource occurs after the first starting time resource, and the first reserved resource and the second reserved resource satisfy the inter-UE blocking condition further based on the second transmission priority value being smaller than the first transmission priority value.

In one aspect, the first reserved resource is associated with a first CAPC value and the second reserved resource is associated with a second CAPC value, wherein the second starting time resource occurs after the first starting time resource, and the first reserved resource and the second reserved resource satisfy the inter-UE blocking condition further based on the second CAPC value being smaller than the first CAPC value.

In one aspect, the first SCI indicates the first CAPC value and the second SCI indicates the second CAPC value.

In one aspect, the first reserved resource and the second reserved resource satisfy the inter-UE blocking condition further based on a distance between the second UE and the third UE satisfying an inter-UE distance threshold.

In one aspect, the first reserved resource and the second reserved resource satisfy the inter-UE blocking condition further based on the second UE belonging to a second UE list associated with the third UE and the third UE belonging to a first UE list associated with the second UE.

In one aspect, the first UE list indicates a first set of UEs from which a respective received signal strength indicator (RSSI) at the second UE satisfies a first RSSI threshold, and the second UE list indicates a second set of UEs from which a respective RSSI at the third UE satisfies a second RSSI threshold.

In one aspect, the first RSSI threshold equals the second RSSI threshold.

In one aspect, the first RSSI threshold is different from the second RSSI threshold.

In one aspect, transmitting the inter-UE coordination information comprises transmitting the inter-UE coordination information to the second UE based on a destination condition being satisfied.

In one aspect, the second UE is associated with a first transmission priority value and the third UE is associated with a second transmission priority value, and the destination condition is satisfied based on the first transmission priority value being larger than the second transmission priority value.

In one aspect, the second UE is associated with a first CAPC value and the third UE is associated with a second CAPC value, and the destination condition is satisfied based on the first CAPC value being larger than the second CAPC value.

In one aspect, the first reserved resource has a first starting time resource and the second reserved resource has a second starting time resource, and the destination condition is satisfied based on the first starting time resource occurring before the second starting time resource.

In one aspect, the inter-UE coordination information indicates a quantity of gap symbols and a slot index associated with a slot that includes the gap symbols.

In one aspect, the quantity of gap symbols is based on a quantity of reserved symbols indicated in at least one of the first SCI or the second SCI.

In one aspect, the quantity of reserved symbols is associated with a type-1 listen-before-talk procedure.

In one aspect, the quantity of gap symbols is based on a first quantity of reserved symbols indicated in the first SCI and a second quantity of reserved symbols indicated in the second SCI.

In one aspect, the quantity of gap symbols is equal to a maximum of the first quantity of reserved symbols and the second quantity of reserved symbols.

In one aspect, the inter-UE coordination information indicates a slot index associated with a last slot of one or more slots associated with an inter-UE blocking mitigation operation.

In one aspect, the inter-UE blocking mitigation operation comprises a gap maintenance operation or a resource reselection procedure.

In one aspect, the inter-UE blocking indication indicates an occurrence of inter-UE blocking associated with the second UE and the third UE.

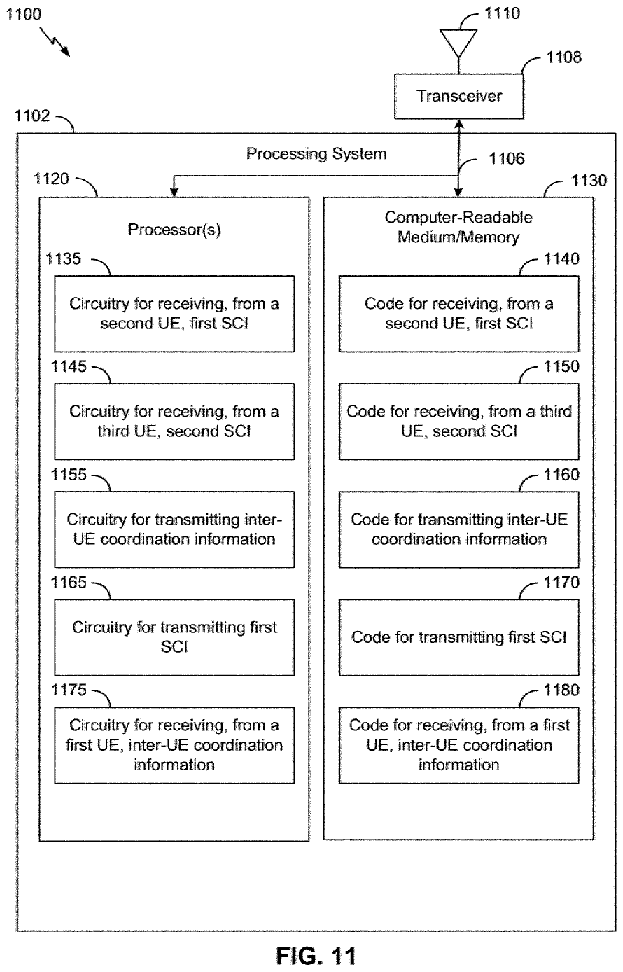

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

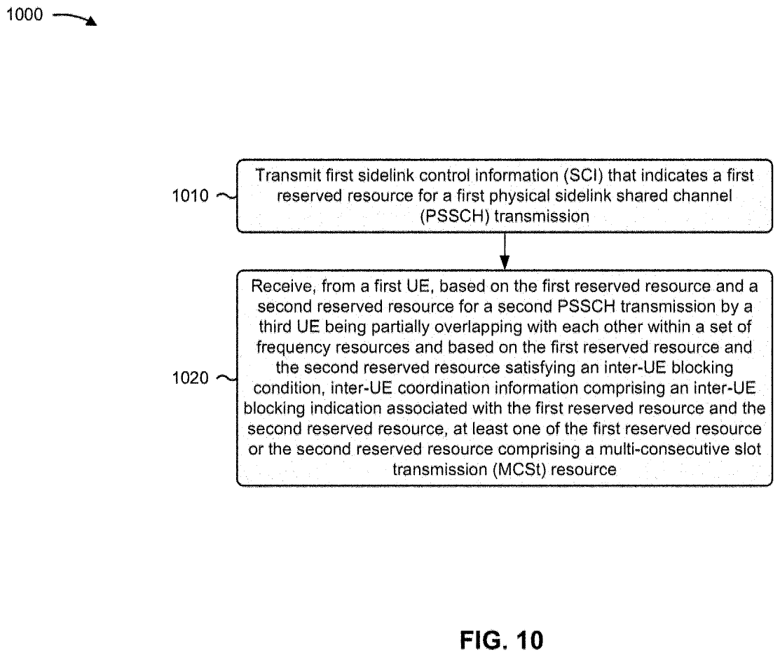

FIG. 10 shows a method 1000 for wireless communications by a second UE, such as UE 120.

Method 1000 begins at 1010 with transmitting first SCI that indicates a first reserved resource for a first PSSCH transmission.

Method 1000 then proceeds to step 1020 with receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising an MCSt resource.

In one aspect, the first reserved resource has a first starting time resource and the second reserved resource has a second starting time resource, wherein the first reserved resource is frequency division multiplexed with the second reserved resource, and the first reserved resource and the second reserved resource satisfy the inter-UE blocking condition based on the first starting time resource being different from the second starting time resource.

In one aspect, the first reserved resource is associated with a first transmission priority value and the second reserved resource is associated with a second transmission priority value, wherein the second starting time resource occurs after the first starting time resource, and the first reserved resource and the second reserved resource satisfy the inter-UE blocking condition further based on the second transmission priority value being smaller than the first transmission priority value.

In one aspect, the first reserved resource is associated with a first CAPC value and the second reserved resource is associated with a second CAPC value, wherein the second starting time resource occurs after the first starting time resource, and the first reserved resource and the second reserved resource satisfy the inter-UE blocking condition further based on the second CAPC value being smaller than the first CAPC value.

In one aspect, the first SCI indicates the first CAPC value and second SCI indicates the second CAPC value.

In one aspect, the first reserved resource and the second reserved resource satisfy the inter-UE blocking condition further based on a distance between the second UE and the third UE satisfying an inter-UE distance threshold.

In one aspect, the first reserved resource and the second reserved resource satisfy the inter-UE blocking condition further based on the second UE belonging to a second UE list associated with the third UE and the third UE belonging to a first UE list associated with the second UE.

In one aspect, the first UE list indicates a first set of UEs from which a respective received signal strength indicator (RSSI) at the second UE satisfies a first RSSI threshold, and the second UE list indicates a second set of UEs from which a respective RSSI at the third UE satisfies a second RSSI threshold.

In one aspect, the first RSSI threshold equals the second RSSI threshold.

In one aspect, the first RSSI threshold is different from the second RSSI threshold.

In one aspect, receiving the inter-UE coordination information comprises receiving the inter-UE coordination information based on a destination condition being satisfied.

In one aspect, the second UE is associated with a first transmission priority value and the third UE is associated with a second transmission priority value, and the destination condition is satisfied based on the first transmission priority value being larger than the second transmission priority value.

In one aspect, the second UE is associated with a first CAPC value and the third UE is associated with a second CAPC value, and the destination condition is satisfied based on the first CAPC value being larger than the second CAPC value.

In one aspect, the first reserved resource has a first starting time resource and the second reserved resource has a second starting time resource, and the destination condition is satisfied based on the first starting time resource occurring before the second starting time resource.

In one aspect, the inter-UE coordination information indicates a quantity of gap symbols and a slot index associated with a slot that includes the gap symbols.

In one aspect, the quantity of gap symbols is based on a quantity of reserved symbols indicated in at least one of the first SCI or second SCI that indicates the second reserved resource.

In one aspect, the quantity of reserved symbols is associated with a type-1 listen-before-talk procedure.

In one aspect, the quantity of gap symbols is based on a first quantity of reserved symbols indicated in the first SCI and a second quantity of reserved symbols indicated in second SCI that indicates the second reserved resource.

In one aspect, the quantity of gap symbols is equal to a maximum of the first quantity of reserved symbols and the second quantity of reserved symbols.

In one aspect, the inter-UE coordination information indicates a slot index associated with a last slot of one or more slots associated with an inter-UE blocking mitigation operation.

In one aspect, the inter-UE blocking mitigation operation comprises a gap maintenance operation or a resource reselection procedure.

In one aspect, the inter-UE blocking indication indicates an occurrence of inter-UE blocking associated with the second UE and the third UE.

In one aspect, method 1000 further includes performing an inter-UE blocking mitigation operation based on receiving the inter-UE coordination information.

In one aspect, performing the inter-UE blocking mitigation operation comprises maintaining one or more gap symbols in a slot that starts prior to a first slot of the second reserved resource.

In one aspect, performing the inter-UE blocking mitigation operation comprises maintaining one gap symbol in each slot of one or more slots that start prior to a first slot of the second reserved resource.

In one aspect, performing the inter-UE blocking mitigation operation comprises performing a resource reselection procedure.

In one aspect, performing the resource reselection procedure comprises reselecting one or more single-slot resources in lieu of one or more single-slot resources of the first reserved resource.

In one aspect, the first reserved resource comprises an MCSt resource and reselecting the one or more single-slot resources comprises selecting one or more single-slot resources for one or more contiguous slots that occur prior to a start of the second reserved resource.

In one aspect, the first reserved resource comprises a first MCSt resource and performing the resource reselection procedure comprises selecting a second MCSt resource in lieu of the first MCSt resource.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

FIG. 11 is a diagram illustrating an example of an implementation of code and circuitry for a communications device 1100, in accordance with the present disclosure. The communications device 1100 may be a UE, or a UE may include the communications device 1100.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In various aspects, the computer-readable medium/memory 1130 may be representative of memory 282, as described with respect to FIG. 2. In certain aspects, the computer-readable medium/memory 1130 is configured to store instructions (e.g., computer-executable code, processor-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

As shown in FIG. 11, the communications device 1100 may include circuitry for receiving, from a second UE, first SCI that indicates a first reserved resource for a first PSSCH transmission (circuitry 1135).

As shown in FIG. 11, the communications device 1100 may include, stored in computer-readable medium/memory 1130, code for receiving, from a second UE, first SCI that indicates a first reserved resource for a first PSSCH transmission (code 1140).

As shown in FIG. 11, the communications device 1100 may include circuitry for receiving, from a third UE, second SCI that indicates a second reserved resource for a second PSSCH transmission, at least one of the first reserved resource or the second reserved resource comprising an MCSt resource (circuitry 1145).

As shown in FIG. 11, the communications device 1100 may include, stored in computer-readable medium/memory 1130, code for receiving, from a third UE, second SCI that indicates a second reserved resource for a second PSSCH transmission, at least one of the first reserved resource or the second reserved resource comprising an MCSt resource (code 1150).

As shown in FIG. 11, the communications device 1100 may include circuitry for transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource (circuitry 1155).

As shown in FIG. 11, the communications device 1100 may include, stored in computer-readable medium/memory 1130, code for transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource (code 1160).

Various components of the communications device 1100 may provide means for performing the method 900 described with respect to FIG. 9, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

In certain aspects, the computer-readable medium/memory 1130 is configured to store instructions (e.g., computer-executable code, processor-executable code) that when executed by the one or more processors 1120, cause the one or more processors 1120 to perform the method 1000 described with respect to FIG. 10, or any aspect related to it. Note that reference to a processor performing a function of communications device 1100 may include one or more processors performing that function of communications device 1100.

As shown in FIG. 11, the communications device 1100 may include circuitry for transmitting first SCI that indicates a first reserved resource for a first PSSCH transmission (circuitry 1165).

As shown in FIG. 11, the communications device 1100 may include, stored in computer-readable medium/memory 1130, code for transmitting first SCI that indicates a first reserved resource for a first PSSCH transmission (code 1170).

As shown in FIG. 11, the communications device 1100 may include circuitry for receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising an MCSt resource (circuitry 1175).

As shown in FIG. 11, the communications device 1100 may include, stored in computer-readable medium/memory 1130, code for receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising a MCSt resource (code 1180).

Various components of the communications device 1100 may provide means for performing the method 1000 described with respect to FIG. 10, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

FIG. 11 is provided as an example. Other examples may differ from what is described in connection with FIG. 11.

The following provides an overview of some Aspects of the present disclosure:

Aspect 1: A method of wireless communication performed by a first user equipment (UE), comprising: receiving, from a second UE, first sidelink control information (SCI) that indicates a first reserved resource for a first physical sidelink shared channel (PSSCH) transmission; receiving, from a third UE, second SCI that indicates a second reserved resource for a second PSSCH transmission, at least one of the first reserved resource or the second reserved resource comprising an MCSt resource; and transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource.

Aspect 2: The method of Aspect 1, wherein the first reserved resource has a first starting time resource and wherein the second reserved resource has a second starting time resource, wherein the first reserved resource is frequency division multiplexed with the second reserved resource, and wherein the first reserved resource and the second reserved resource satisfy the inter-UE blocking condition based on the first starting time resource being different from the second starting time resource.

Aspect 3: The method of Aspect 2, wherein the first reserved resource is associated with a first transmission priority value and the second reserved resource is associated with a second transmission priority value, wherein the second starting time resource occurs after the first starting time resource, and wherein the first reserved resource and the second reserved resource satisfy the inter-UE blocking condition further based on the second transmission priority value being smaller than the first transmission priority value.

Aspect 4: The method of either of Aspects 2 or 3, wherein the first reserved resource is associated with a first channel access priority class (CAPC) value and the second reserved resource is associated with a second CAPC value, wherein the second starting time resource occurs after the first starting time resource, and wherein the first reserved resource and the second reserved resource satisfy the inter-UE blocking condition further based on the second CAPC value being smaller than the first CAPC value.

Aspect 5: The method of Aspect 4, wherein the first SCI indicates the first CAPC value and the second SCI indicates the second CAPC value.

Aspect 6: The method of any of Aspects 2-5, wherein the first reserved resource and the second reserved resource satisfy the inter-UE blocking condition further based on a distance between the second UE and the third UE satisfying an inter-UE distance threshold.

Aspect 7: The method of any of Aspects 2-6, wherein the first reserved resource and the second reserved resource satisfy the inter-UE blocking condition further based on the second UE belonging to a second UE list associated with the third UE and the third UE belonging to a first UE list associated with the second UE.

Aspect 8: The method of Aspect 7, wherein the first UE list indicates a first set of UEs from which a respective received signal strength indicator (RSSI) at the second UE satisfies a first RSSI threshold, and wherein the second UE list indicates a second set of UEs from which a respective RSSI at the third UE satisfies a second RSSI threshold.

Aspect 9: The method of Aspect 8, wherein the first RSSI threshold equals the second RSSI threshold.

Aspect 10: The method of Aspect 8, wherein the first RSSI threshold is different from the second RSSI threshold.

Aspect 11: The method of any of Aspects 1-10, wherein transmitting the inter-UE coordination information comprises transmitting the inter-UE coordination information to the second UE based on a destination condition being satisfied.

Aspect 12: The method of Aspect 11, wherein the second UE is associated with a first transmission priority value and the third UE is associated with a second transmission priority value, and wherein the destination condition is satisfied based on the first transmission priority value being larger than the second transmission priority value.

Aspect 13: The method of either of claims 11 or 12, wherein the second UE is associated with a first channel access priority class (CAPC) value and the third UE is associated with a second CAPC value, and wherein the destination condition is satisfied based on the first CAPC value being larger than the second CAPC value.

Aspect 14: The method of any of Aspects 11-13, wherein the first reserved resource has a first starting time resource and wherein the second reserved resource has a second starting time resource, and wherein the destination condition is satisfied based on the first starting time resource occurring before the second starting time resource.

Aspect 15: The method of any of Aspects 1-14, wherein the inter-UE coordination information indicates a quantity of gap symbols and a slot index associated with a slot that includes the gap symbols.

Aspect 16: The method of Aspect 15, wherein the quantity of gap symbols is based on a quantity of reserved symbols indicated in at least one of the first SCI or the second SCI.

Aspect 17: The method of Aspect 16, wherein the quantity of reserved symbols is associated with a type-1 listen-before-talk procedure.

Aspect 18: The method of any of Aspects 15-17, wherein the quantity of gap symbols is based on a first quantity of reserved symbols indicated in the first SCI and a second quantity of reserved symbols indicated in the second SCI.

Aspect 19: The method of Aspect 18, wherein the quantity of gap symbols is equal to a maximum of the first quantity of reserved symbols and the second quantity of reserved symbols.

Aspect 20: The method of any of Aspects 1-19, wherein the inter-UE coordination information indicates a slot index associated with a last slot of one or more slots associated with an inter-UE blocking mitigation operation.

Aspect 21: The method of Aspect 20, wherein the inter-UE blocking mitigation operation comprises a gap maintenance operation or a resource reselection procedure.

Aspect 22: The method of any of Aspects 1-21, wherein the inter-UE blocking indication indicates an occurrence of inter-UE blocking associated with the second UE and the third UE.

Aspect 23: A method of wireless communication performed by a second user equipment (UE), comprising: transmitting first sidelink control information (SCI) that indicates a first reserved resource for a first physical sidelink shared channel (PSSCH) transmission; and receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising a multi-consecutive slot transmission (MCSt) resource.

Aspect 24: The method of Aspect 23, wherein the first reserved resource has a first starting time resource and wherein the second reserved resource has a second starting time resource, wherein the first reserved resource is frequency division multiplexed with the second reserved resource, and wherein the first reserved resource and the second reserved resource satisfy the inter-UE blocking condition based on the first starting time resource being different from the second starting time resource.

Aspect 25: The method of Aspect 24, wherein the first reserved resource is associated with a first transmission priority value and the second reserved resource is associated with a second transmission priority value, wherein the second starting time resource occurs after the first starting time resource, and wherein the first reserved resource and the second reserved resource satisfy the inter-UE blocking condition further based on the second transmission priority value being smaller than the first transmission priority value.

Aspect 26: The method of either of Aspects 24 or 25, wherein the first reserved resource is associated with a first channel access priority class (CAPC) value and the second reserved resource is associated with a second CAPC value, wherein the second starting time resource occurs after the first starting time resource, and wherein the first reserved resource and the second reserved resource satisfy the inter-UE blocking condition further based on the second CAPC value being smaller than the first CAPC value.

Aspect 27: The method of Aspect 26, wherein the first SCI indicates the first CAPC value and second SCI indicates the second CAPC value.

Aspect 28: The method of any of Aspects 24-27, wherein the first reserved resource and the second reserved resource satisfy the inter-UE blocking condition further based on a distance between the second UE and the third UE satisfying an inter-UE distance threshold.

Aspect 29: The method of any of Aspects 24-28, wherein the first reserved resource and the second reserved resource satisfy the inter-UE blocking condition further based on the second UE belonging to a second UE list associated with the third UE and the third UE belonging to a first UE list associated with the second UE.

Aspect 30: The method of Aspect 29, wherein the first UE list indicates a first set of UEs from which a respective received signal strength indicator (RSSI) at the second UE satisfies a first RSSI threshold, and wherein the second UE list indicates a second set of UEs from which a respective RSSI at the third UE satisfies a second RSSI threshold.

Aspect 31: The method of Aspect 30, wherein the first RSSI threshold equals the second RSSI threshold.

Aspect 32: The method of Aspect 30, wherein the first RSSI threshold is different from the second RSSI threshold.

Aspect 33: The method of any of Aspects 23-32, wherein receiving the inter-UE coordination information comprises receiving the inter-UE coordination information based on a destination condition being satisfied.

Aspect 34: The method of Aspect 33, wherein the second UE is associated with a first transmission priority value and the third UE is associated with a second transmission priority value, and wherein the destination condition is satisfied based on the first transmission priority value being larger than the second transmission priority value.

Aspect 35: The method of either of claims 33 or 34, wherein the second UE is associated with a first channel access priority class (CAPC) value and the third UE is associated with a second CAPC value, and wherein the destination condition is satisfied based on the first CAPC value being larger than the second CAPC value.

Aspect 36: The method of any of Aspects 33-35, wherein the first reserved resource has a first starting time resource and wherein the second reserved resource has a second starting time resource, and wherein the destination condition is satisfied based on the first starting time resource occurring before the second starting time resource.

Aspect 37: The method of any of Aspects 23-36, wherein the inter-UE coordination information indicates a quantity of gap symbols and a slot index associated with a slot that includes the gap symbols.

Aspect 38: The method of Aspect 37, wherein the quantity of gap symbols is based on a quantity of reserved symbols indicated in at least one of the first SCI or second SCI that indicates the second reserved resource.

Aspect 39: The method of Aspect 38, wherein the quantity of reserved symbols is associated with a type-1 listen-before-talk procedure.

Aspect 40: The method of any of Aspects 37-39, wherein the quantity of gap symbols is based on a first quantity of reserved symbols indicated in the first SCI and a second quantity of reserved symbols indicated in second SCI that indicates the second reserved resource.

Aspect 41: The method of Aspect 40, wherein the quantity of gap symbols is equal to a maximum of the first quantity of reserved symbols and the second quantity of reserved symbols.

Aspect 42: The method of any of Aspects 23-41, wherein the inter-UE coordination information indicates a slot index associated with a last slot of one or more slots associated with an inter-UE blocking mitigation operation.

Aspect 43: The method of Aspect 42, wherein the inter-UE blocking mitigation operation comprises a gap maintenance operation or a resource reselection procedure.

Aspect 44: The method of any of Aspects 23-43, wherein the inter-UE blocking indication indicates an occurrence of inter-UE blocking associated with the second UE and the third UE.

Aspect 45: The method of any of Aspects 23-44, further comprising performing an inter-UE blocking mitigation operation based on receiving the inter-UE coordination information.

Aspect 46: The method of Aspect 45, wherein performing the inter-UE blocking mitigation operation comprises maintaining one or more gap symbols in a slot that starts prior to a first slot of the second reserved resource.

Aspect 47: The method of any of Aspects 45-46, wherein performing the inter-UE blocking mitigation operation comprises maintaining one gap symbol in each slot of one or more slots that start prior to a first slot of the second reserved resource.

Aspect 48: The method of any of Aspects 45-47, wherein performing the inter-UE blocking mitigation operation comprises performing a resource reselection procedure.

Aspect 49: The method of Aspect 48, wherein performing the resource reselection procedure comprises reselecting one or more single-slot resources in lieu of one or more single-slot resources of the first reserved resource.

Aspect 50: The method of Aspect 49, wherein the first reserved resource comprises an MCSt resource and wherein reselecting the one or more single-slot resources comprises selecting one or more single-slot resources for one or more contiguous slots that occur prior to a start of the second reserved resource.

Aspect 51: The method of any of Aspects 48-50, wherein the first reserved resource comprises a first MCSt resource and wherein performing the resource reselection procedure comprises selecting a second MCSt resource in lieu of the first MCSt resource.

Aspect 52: An apparatus for wireless communication at a device, comprising a processor; memory coupled with the processor; and instructions stored in the memory and executable by the processor to cause the apparatus to perform the method of one or more of Aspects 1-22.

Aspect 53: A device for wireless communication, comprising a memory and one or more processors coupled to the memory, the one or more processors configured to perform the method of one or more of Aspects 1-22.

Aspect 54: An apparatus for wireless communication, comprising at least one means for performing the method of one or more of Aspects 1-22.

Aspect 55: A non-transitory computer-readable medium storing code for wireless communication, the code comprising instructions executable by a processor to perform the method of one or more of Aspects 1-22.

Aspect 56: A non-transitory computer-readable medium storing a set of instructions for wireless communication, the set of instructions comprising one or more instructions that, when executed by one or more processors of a device, cause the device to perform the method of one or more of Aspects 1-22.

Aspect 57: An apparatus for wireless communication at a device, comprising a processor; memory coupled with the processor; and instructions stored in the memory and executable by the processor to cause the apparatus to perform the method of one or more of Aspects 23-51.

Aspect 58: A device for wireless communication, comprising a memory and one or more processors coupled to the memory, the one or more processors configured to perform the method of one or more of Aspects 23-51.

Aspect 59: An apparatus for wireless communication, comprising at least one means for performing the method of one or more of Aspects 23-51.

Aspect 60: A non-transitory computer-readable medium storing code for wireless communication, the code comprising instructions executable by a processor to perform the method of one or more of Aspects 23-51.

Aspect 61: A non-transitory computer-readable medium storing a set of instructions for wireless communication, the set of instructions comprising one or more instructions that, when executed by one or more processors of a device, cause the device to perform the method of one or more of Aspects 23-51.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication performed by a first user equipment (UE), comprising:
receiving, from a second UE, first sidelink control information (SCI) that indicates a first reserved resource for a first physical sidelink shared channel (PSSCH) transmission;
receiving, from a third UE, second SCI that indicates a second reserved resource for a second PSSCH transmission, at least one of the first reserved resource or the second reserved resource comprising a multi-consecutive slot transmission (MCSt) resource; and
transmitting, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource.

2. The method of claim 1, wherein the first reserved resource has a first starting time resource and wherein the second reserved resource has a second starting time resource, wherein the first reserved resource is frequency division multiplexed with the second reserved resource, and wherein the first reserved resource and the second reserved resource satisfy the inter-UE blocking condition based on the first starting time resource being different from the second starting time resource.

3. The method of claim 2, wherein the first reserved resource is associated with a first transmission priority value and the second reserved resource is associated with a second transmission priority value, wherein the second starting time resource occurs after the first starting time resource, and wherein the first reserved resource and the second reserved resource satisfy the inter-UE blocking condition further based on the second transmission priority value being smaller than the first transmission priority value.

4. The method of claim 2, wherein the first reserved resource is associated with a first channel access priority class (CAPC) value and the second reserved resource is associated with a second CAPC value, wherein the second starting time resource occurs after the first starting time resource, and wherein the first reserved resource and the second reserved resource satisfy the inter-UE blocking condition further based on the second CAPC value being smaller than the first CAPC value.

5. The method of claim 4, wherein the first SCI indicates the first CAPC value and the second SCI indicates the second CAPC value.

6. The method of claim 2, wherein the first reserved resource and the second reserved resource satisfy the inter-UE blocking condition further based on a distance between the second UE and the third UE satisfying an inter-UE distance threshold, or wherein the first reserved resource and the second reserved resource satisfy the inter-UE blocking condition further based on the second UE belonging to a second UE list associated with the third UE and the third UE belonging to a first UE list associated with the second UE.

7. (canceled)

8. The method of claim 6, wherein the first reserved resource and the second reserved resource satisfy the inter-UE blocking condition further based on the second UE belonging to the second UE list associated with the third UE and the third UE belonging to the first UE list associated with the second UE, and wherein the first UE list indicates a first set of UEs from which a respective received signal strength indicator (RSSI) at the second UE satisfies a first RSSI threshold, and wherein the second UE list indicates a second set of UEs from which a respective RSSI at the third UE satisfies a second RSSI threshold.

9. The method of claim 8, wherein the first RSSI threshold equals the second RSSI threshold, or wherein the first RSSI threshold is different from the second RSSI threshold.

10. (canceled)

11. The method of claim 1, wherein transmitting the inter-UE coordination information comprises transmitting the inter-UE coordination information to the second UE based on a destination condition being satisfied.

12. The method of claim 11, wherein:
the second UE is associated with a first transmission priority value and the third UE is associated with a second transmission priority value, and wherein the destination condition is satisfied based on the first transmission priority value being larger than the second transmission priority value, or
the second UE is associated with a first channel access priority class (CAPC) value and the third UE is associated with a second CAPC value, and wherein the destination condition is satisfied based on the first CAPC value being larger than the second CAPC value, or
the first reserved resource has a first starting time resource and wherein the second reserved resource has a second starting time resource, and wherein the destination condition is satisfied based on the first starting time resource occurring before the second starting time resource.

13. (canceled)

14. (canceled)

15. (canceled)

16. The method of claim 1, wherein:
the inter-UE coordination information indicates a quantity of gap symbols that is based on a quantity of reserved symbols indicated in at least one of the first SCI or the second SCI, wherein the quantity of reserved symbols is associated with a type-1 listen-before-talk procedure, or
the quantity of gap symbols is based on a first quantity of reserved symbols indicated in the first SCI and a second quantity of reserved symbols indicated in the second SCI, wherein the quantity of gap symbols is equal to a maximum of the first quantity of reserved symbols and the second quantity of reserved symbols.

17. (canceled)

18. (canceled)

19. (canceled)

20. The method of claim 1, wherein:
the inter-UE coordination information indicates a quantity of gap symbols and a slot index associated with a slot that includes the gap symbols, or
the inter-UE coordination information indicates a slot index associated with a last slot of one or more slots associated with an inter-UE blocking mitigation operation.

21. The method of claim 20, wherein the inter-UE coordination information indicates a slot index associated with a last slot of one or more slots associated with an inter-UE blocking mitigation operation, and wherein the inter-UE blocking mitigation operation comprises a gap maintenance operation or a resource reselection procedure.

22. The method of claim 1, wherein the inter-UE blocking indication indicates an occurrence of inter-UE blocking associated with the second UE and the third UE.

23. A method of wireless communication performed by a second user equipment (UE), comprising:
transmitting first sidelink control information (SCI) that indicates a first reserved resource for a first physical sidelink shared channel (PSSCH) transmission; and
receiving, from a first UE, based on the first reserved resource and a second reserved resource for a second PSSCH transmission by a third UE being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource, at least one of the first reserved resource or the second reserved resource comprising a multi-consecutive slot transmission (MCSt) resource.

24. The method of claim 23, further comprising performing an inter-UE blocking mitigation operation based on receiving the inter-UE coordination information, wherein:
performing the inter-UE blocking mitigation operation comprises maintaining one or more gap symbols in a slot that starts prior to a first slot of the second reserved resource, or
performing the inter-UE blocking mitigation operation comprises maintaining one gap symbol in each slot of one or more slots that start prior to a first slot of the second reserved resource, or
performing the inter-UE blocking mitigation operation comprises performing a resource reselection procedure.

25. (canceled)

26. (canceled)

27. (canceled)

28. The method of claim 24, wherein performing the inter-UE blocking mitigation operation comprises performing a resource reselection procedure, and wherein performing the resource reselection procedure comprises reselecting one or more single-slot resources in lieu of one or more single-slot resources of the first reserved resource.

29. The method of claim 28, wherein the first reserved resource comprises an MCSt resource and wherein reselecting the one or more single-slot resources comprises selecting one or more single-slot resources for one or more contiguous slots that occur prior to a start of the second reserved resource

30. The method of claim 24, wherein the first reserved resource comprises a first MCSt resource and wherein performing the resource reselection procedure comprises selecting a second MCSt resource in lieu of the first MCSt resource.

31. A first user equipment (UE) configured for wireless communications, comprising:
a memory comprising processor-executable instructions; and
a processor configured to execute the processor-executable instructions and cause the first UE to:
receive, from a second UE, first sidelink control information (SCI) that indicates a first reserved resource for a first physical sidelink shared channel (PSSCH) transmission;
receive, from a third UE, second SCI that indicates a second reserved resource for a second PSSCH transmission, at least one of the first reserved resource or the second reserved resource comprising a multi-consecutive slot transmission (MCSt) resource; and
transmit, based on the first reserved resource and the second reserved resource being partially overlapping with each other within a set of frequency resources and based on the first reserved resource and the second reserved resource satisfying an inter-UE blocking condition, inter-UE coordination information comprising an inter-UE blocking indication associated with the first reserved resource and the second reserved resource.
